(19) United States
(12) Patent Application Publication
(10) Pub. No.: US 2016/0119890 A1
(43) Pub. Date: Apr. 28, 2016

(54) METHOD AND CONTROL SYSTEM FOR OPERATING AT LEAST ONE APPARATUS THAT IS ARRANGED IN A BUILDING

(71) Applicant: AUDI AG, Ingolstadt (DE)

(72) Inventor: Ralph HOLLMIG, Ingolstadt (DE)

(73) Assignee: AUDI AG, Ingolstadt (DE)

(21) Appl. No.: 14/887,604

(22) Filed: Oct. 20, 2015

(30) Foreign Application Priority Data
Oct. 25, 2014 (DE) 10 2014 015 853.5

(51) Int. Cl. H04W 56/00; H04L 12/28

(52) U.S. Cl. CPC H04W 56/0025; H04L 12/283; H04L 2012/2841

(57) ABSTRACT

A method operates at least one apparatus that is arranged in a building. The method involves producing a wireless connection between a communication unit of a motor vehicle and the apparatus, transmitting to the apparatus in a wireless manner by the communication unit data that define an operating mode of the apparatus, and operating the apparatus in dependence upon the data that are transmitted to the apparatus. The data are provided and synchronized with one another both by a central data processing device as well as by the communication unit. A control system can be used with the method.

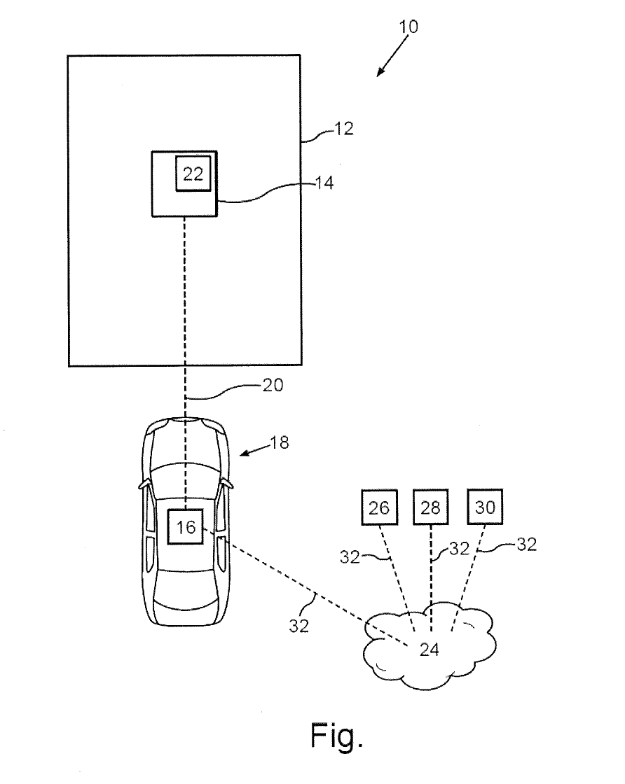

### CROSS REFERENCE TO RELATED APPLICATIONS

This application is based on and hereby claims priority to German Application No. 10 2014 015 853.5 filed on Oct. 25, 2014, the contents of which are hereby incorporated by reference.

### BACKGROUND

The invention relates to a method and a control system for operating at least one apparatus that is arranged in a building.

It is known to control various apparatuses that are arranged in a building such as by way of example a heating system, household devices or the like by way of a motor vehicle. By way of example, DE 198 49 194 A1 discloses a motor vehicle having a communication unit that is embodied for the purpose of producing a wireless connection to an apparatus and to control said apparatus.

DE 199 61 872 A1 discloses a method, wherein an apparatus that is arranged in a building, by way of example a heating system, is controlled in dependence upon a detected position of a motor vehicle.

KR 1020070098101 A discloses a method for controlling a home network by a motor vehicle. A graphic user surface is disclosed for controlling the home network in dependence upon a relative position of the motor vehicle in relation to the building.

### SUMMARY

One possible object is to render it possible to improve the control, by a motor vehicle, of an apparatus that is arranged in a building.

The inventor proposes a method for operating at least one apparatus that is arranged in a building and also proposes a control system.

In the case of the proposed method for operating at least one apparatus that is arranged in a building, a wireless connection is produced between a communication unit of a motor vehicle and the apparatus. Data that define an operating mode of the apparatus are subsequently transmitted to the apparatus in a wireless manner by the communication unit. The apparatus is operated in dependence upon the data that are transmitted to the apparatus. The method is characterized by virtue of the fact that the data are provided and synchronized with one another both by a central data processing device as well as by the communication unit.

The synchronization occurs preferably by way of an internet connection. One or also more apparatuses within the building, such as by way of example a heating system, a stereo system, a lighting system and the like are already set in a manner desired by the driver of the vehicle by the proposed method before said driver enters the building. This can either occur automatically as soon as the wireless connection is produced or is also effected by an active input from the user. By way of example, the at least one apparatus or also further apparatuses can be connected to a home network, for example in the form of a WLAN (wireless local area network) and/or said apparatuses can comprise respective Bluetooth modules by way of which the wireless connection to the communication unit of the motor vehicle can be produced.

By virtue of the fact that the data are provided and synchronized with one another both by a central data processing device as well as by the communication unit, the data can always be maintained as up to date as possible in a particularly simple manner. The term “central data processing device” is in particular to be understood to mean a so-called “cloud” by which the data synchronization occurs.

In one advantageous embodiment, it is provided that the data are provided in a person-specific—in particular driver-specific—manner by the data processing device and are transmitted to said data processing device in dependence upon a respective driver of the motor vehicle when activating the communication unit. By way of example, multiple different drivers can have a respective user account, wherein user-specific respective data are provided by the central data processing device. The allocation to a specific user account and consequently to a specific driver can occur by way of example with reference to a vehicle key that is carried by the respective driver. Alternatively or in addition thereto, it is also possible that by way of example a camera system is integrated into the motor vehicle and said camera is used in turn to identify a driver and allocate said driver to the user account. In particular, in the case of providing the person-specific data, the advantage of synchronizing the data between the central data processing device and the communication unit of the motor vehicle becomes clear. The person-specific or rather user-specific data that are provided and which define an operating mode of the at least one apparatus are automatically transmitted to the communication unit without the intervention of the respective driver and are consequently available without the intervention of the driver concerned.

A further advantageous embodiment provides that a function that is embodied by a function unit of the motor vehicle is interrupted as soon as a driver of the motor vehicle leaves said motor vehicle and the same function is continued by the apparatus as soon as it is determined that the driver is entering the building. By way of example, during the journey in the motor vehicle, a specific piece of music can be played by an infotainment system of the motor vehicle. The playback of the music piece is interrupted as soon as the driver leaves the motor vehicle. If the driver then enters the building, a stereo system is thus automatically operated in such a manner that the piece of music is continued precisely from the point at which it was interrupted as the driver exited the vehicle. By the data that previously defined the operating mode of the apparatus, in this case in other words the stereo system, it is possible for a desired standard volume of the relevant stereo system to be set in advance. In addition to the data that define the operating mode of the apparatus, data that relate to the function, in the present example in other words information regarding at which point the relevant music was interrupted, are transmitted to the apparatus likewise in a wireless manner by the communication unit. By way of example, a vehicle key that is carried by the driver is used to detect when the driver enters the building in order to then control the stereo system in such a manner that in precisely the moment in which the driver enters the building said stereo system is controlled in such a manner that the piece of music that was previously interrupted in the motor vehicle is now seamlessly continued by the stereo system that is arranged in the building.

In accordance with a further advantageous embodiment, it is provided that the data that define the operating mode of the apparatus are provided in addition by a computer, tablet computer and/or smartphone and are synchronized with the data that are provided by the central data processing device. By way of example, the data that define the operating mode of the apparatus in other words can be changed by a computer, a tablet-computer, a smartphone or also by way of a corresponding interface of the motor vehicle that is designed for this purpose. As soon as a change to the data is performed, it is preferred that an automatic synchronization occurs with the data that are provided by the central data processing device so that these data are always maintained so as to reflect the currently prevailing status. Accordingly, the data that define the operating mode of the apparatus can consequently be changed in many ways that are in each case particularly comfortable for a user, wherein these data can always be provided in their current form in the motor vehicle as a result of the synchronization with the central data processing device.

The proposed control system comprises at least one apparatus that is arranged in a building. Furthermore, the control system comprises a communication unit of a motor vehicle, said communication unit being embodied for the purpose of producing a wireless connection to the apparatus and for the purpose of transmitting to the apparatus in a wireless manner data that define an operating mode of the apparatus. In addition, the control system comprises a control device that is embodied for the purpose of operating the apparatus in dependence upon the data that are transmitted to the apparatus. The proposed control system is characterized by virtue of the fact that both the communication unit as well as a central data processing device of the control system are embodied for the purpose of providing and synchronizing the data with one another. Advantageous embodiments of the proposed method in accordance are to be seen as advantageous embodiments of the proposed control system. The control system includes the relevant equipment for implementing the method.

One advantageous embodiment of the control system provides that the communication unit is embodied for the purpose of producing the wireless connection in the form of a WLAN, Bluetooth and/or mobile network connection. By way of example, an integrated WLAN Hotspot can be provided in the motor vehicle and by way of said WLAN Hotspot in particular smartphones or also tablet computers can be coupled to an internet connection that is provided by the motor vehicle. A WLAN Hotspot of this type that is already present in the motor vehicle is then preferably also used as the communication unit. Alternatively, or in addition thereto, the motor vehicle can also comprise a Bluetooth interface that is already present by way of example for coupling mobile network devices, for example in the form of smartphones or the like. Consequently, valuable equipment that is already present in the motor vehicle is therefore used efficiently over and above its simple use in the motor vehicle.

To conclude, it is provided in accordance with a further advantageous embodiment of the control system that respective apparatuses can be selected by a user interface of the motor vehicle and the data that define an operating mode of the apparatuses can be transmitted to said apparatuses. As a consequence, it is possible by the motor vehicle, more precisely by the relevant user interface of the motor vehicle to select and determine the apparatuses that are arranged in the building and that are to be controlled from the motor vehicle side according to the abovementioned manner by transmitting the data.

### BRIEF DESCRIPTION OF THE DRAWINGS

These and other objects and advantages of the present invention will become more apparent and more readily appreciated from the following description of the preferred embodiments, taken in conjunction with the accompanying drawing of which:

The single FIGURE in which a control system is schematically illustrated, said control system comprising a motor vehicle, an apparatus that is arranged in a building and also a central data processing device.

### DETAILED DESCRIPTION OF THE PREFERRED EMBODIMENT

Reference will now be made in detail to the preferred embodiments of the present invention, examples of which are illustrated in the accompanying drawing, wherein like reference numerals refer to like elements throughout.

A control system that is altogether designated as 10 comprises at least one apparatus 14 that is arranged in a building 12. Furthermore, the control system 10 comprises a communication unit 16 of a motor vehicle 18, said communication unit being embodied for the purpose of producing a wireless connection 20 to the apparatus 14 and also embodied so as to transmit to the apparatus 14 in a wireless manner data that define an operating mode of the apparatus 14. Furthermore, the control system 10 comprises a control device 22 that is embodied for the purpose of operating the apparatus 14 in dependence upon the data that are transmitted to the apparatus 14. In the present case, the control device 22 is a part of the apparatus 14; however, said control device can also be arranged outside of the apparatus.

Furthermore, the control system 10 comprises a central data processing device 24. Both the communication unit 16 as well as the central data processing device 24 are embodied for the purpose of providing the data that define the operating mode of the apparatus 14 and for the purpose of synchronizing the data with one another. The synchronization of the data between the communication unit 16 and the central data processing device 24 is performed by way of a network, by way of example by way of the internet. In other words, a “cloud-based” solution is provided in order to render it possible to provide and synchronize the data that define the operating mode of the apparatus 14.

In the present case, the control system 10 comprises a further computer 26, a tablet computer 28 and also a smartphone 30 by which the data that define the operating mode of the apparatus can likewise be provided and manipulated. The computer 26, the tablet computer 28 and the smartphone 30 and also the central data processing device 24 are likewise embodied for the purpose of synchronizing the data with one another. The data synchronization with the central data processing device 24 occurs in each case preferably by way of respective internet connections 32.

By way of example, the communication unit 16 can be a WLAN Hotspot that is integrated into the motor vehicle 18 and by said WLAN Hotspot different electronic devices, such as by way of example smartphones and tablet computers, can be connected to the internet. Alternatively, the communication unit 16 can also be a Bluetooth module that is used by way of example to connect mobile telephones or also tablet computers to an infotainment system of the motor vehicle 18. The communication unit 16 is consequently multifunctional since said communication unit on the one hand is used for vehicle side infotainment applications and on the other hand is also used for communication with the building side apparatus 14.

A method for operating the apparatus 14 that is arranged in the building 12 is further explained hereinunder. Initially, the wireless connection 20 between the communication unit 16 of the motor vehicle 18 and the apparatus 14 is produced. The apparatus 14 can be different devices such as by way of example a heating system, a stereo system, a television, a lighting system and the like. As soon as the wireless connection 20 is produced, data are transmitted in a wireless manner by the communication unit 16 and an operating mode of the apparatus 14 is defined by said data. Subsequently, the apparatus 14 is operated in dependence upon the data that are transmitted to the apparatus 14.

The apparatus 14 that is arranged in the building 12 is therefore already set in a manner that a driver desires prior to said driver of the motor vehicle 18 entering the building 12. This can either occur automatically as soon as the wireless connection 20 is produced, or can also occur by an active user intervention, by way of example in that the driver performs a corresponding input by way of a graphic user surface that is displayed by the motor vehicle 18.

The wireless connection 20 can either be produced by way of a mobile network, by way of a WLAN connection or also by way of a Bluetooth connection. If by way of example the apparatus 14 is roller blinds or a heating system, it can be expedient if the wireless connection 20 is produced by way of a mobile network connection. The reason for this is that it is consequently also possible to establish the wireless connection 20 even in the case of a greater distance between the motor vehicle 18 and the building 12 so that the heating system or also the roller blinds can be controlled as desired even from a great distance.

If, on the other hand, the apparatus 14 is by way of example a stereo system, it can also thus be entirely sufficient if the wireless connection 20 is established in the form of a WLAN connection. By way of example, the stereo system can be integrated within a WLAN, in other words within a home network, of the building 12. The communication unit 16 then in turn connects automatically to this WLAN and furthermore also to the stereo system.

If a driver of the motor vehicle 18 drives in front of the building 12 and is listening by way of example to a specific piece of music, this piece of music is thus interrupted as soon as the driver leaves the motor vehicle 18. The same piece of music is then continued by the stereo system that is arranged in the building 12 as soon as it is detected that the driver is entering the building 12. In addition to the data that define the operating mode of the apparatus 14, in the present case, in other words the data that define the operating mode of the stereo system, such as by way of example a volume setting that is desired by the driver, the data that relate to the piece of music that is currently being played are still transmitted to the apparatus 14, in other words the stereo system, by way of the wireless connection 20. By way of example, a vehicle key that is being carried by the driver is used to identify the moment when the driver enters the building 12 in order to control the stereo system in a timely manner in such a manner that the piece of music that is interrupted whilst exiting the motor vehicle 18 is then continued using the stereo system that is arranged in the building 12.

The data that define the operating mode of the apparatus 14 are provided in a person-specific, in particular driver-specific manner by the central data processing device 24 and are transmitted to the communication unit 16 in dependence upon a respective driver of the motor vehicle 18 when activating the communication unit 16. By way of example, it can be that multiple drivers use the motor vehicle 18. Each driver can then provide the data that determines the operating mode of the corresponding apparatus 14 in accordance with their preferences. By way of example, this can occur by way of an interface of the motor vehicle 18 by way of which a corresponding graphic user surface is provided by way of which the respective driver can set the data that determine the operating mode of the corresponding apparatus 14. Alternatively or in addition thereto, it can also be provided that the different drivers can provide the data that determine the operating mode of the apparatus 14 by way of the computer 26, the tablet computer 28 and/or the smartphone 30.

Respective user accounts are applied in a person-specific, in other words in particular driver-specific, manner and are stored in the external data processing device 24. The corresponding data that are set by the different drivers and determine the operating mode of the apparatus 14 are stored in a manner that is appropriate for the respective user accounts.

Depending upon which of the drivers are currently entering the motor vehicle 18, the data that are in each case stored in the external data processing device 24 are transmitted to the communication unit 16 by way of the internet connection 32. By way of example, the different drivers can be identified with reference to the respective different vehicle keys that are carried by the drivers. Alternatively or in addition thereto, it can also be provided by way of example a corresponding camera system is installed in the motor vehicle 18 and said camera system is embodied for the purpose of identifying the different drivers.

It is also possible by the described method and control system 10 that a driver or also multiple drivers can send personalized settings during the journey with the motor vehicle 18 to respective apparatuses 14 within a building 12.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1. A method for operating an apparatus that is arranged in a building, comprising:
producing a wireless connection between a communication unit of a motor vehicle and the apparatus;
synchronizing data that define an operating mode of the apparatus, the data being synchronized between the communication unit and a central data processing device;
transmitting to the apparatus in a wireless manner from the communication unit, the data that define the operating mode of the apparatus; and
operating the apparatus in dependence upon the data that define the operating mode.

2. The method according to claim 1, wherein
when the communication unit is activated, the central data processing device transmits to the communication unit driver-specific data that define the operating mode of the apparatus, the driver-specific data being identified and transmitted in dependence upon a respective driver of the motor vehicle.

3. The method according to claim 1, wherein
a function that is performed by a function unit of the motor vehicle is interrupted as soon as a driver of the motor vehicle leaves the motor vehicle, and
the operating mode of the apparatus is defined such that the function is continued by the apparatus as soon as it is determined that the driver is entering the building.

4. The method according to claim 3, wherein
a vehicle key is used to determine that the driver is entering the building.

5. The method according to claim 3, wherein
the function that is performed by the function unit of the motor vehicle is a piece of music that is played by an infotainment system of the motor vehicle, and
the operating mode of the apparatus is defined such that the piece of music is played by the apparatus as soon as it is determined that the driver is entering the building, starting from a point in the piece of music at which the piece of music was interrupted.

6. The method according to claim 5, wherein
the apparatus is a stereo system, and
the operating mode of the apparatus further comprises a volume setting for a stereo system.

7. The method according to claim 1, wherein
a computing unit is also synchronized with the central data processing device, the computing unit being at least one of a computer, a tablet computer and a smartphone, and
the data that define the operating mode of the apparatus are provided at least in part by the computing unit.

8. The method according to claim 7, wherein
the central data processing device transmits to the communication unit the data that define the operating mode, which was provided at least in part by the computing unit.

9. The method according to claim 1, wherein
the apparatus is at least one apparatus selected from the group consisting a heating system, a stereo system, a television, a lighting system and a roller blind system.

10. The method according to claim 1, wherein
as soon as the wireless connection is produced, the apparatus is operated in dependence upon the data that define the operating mode.

11. The method according to claim 1, wherein
the wireless connection is produced between the communication unit and the apparatus via a wireless local area network (WLAN).

12. The method according to claim 1, wherein
the motor vehicle has a plurality of different drivers,
a user account is associated with each of the different drivers, each user account specifying data that define the operating mode of the apparatus,
a current driver is identified with reference to a vehicle key, and
the data that define the operating mode of the apparatus are transmitted from the central data processing device to the communication unit based on a user account associated with the current driver.

13. The method according to claim 1, wherein
the communication unit comprises a Bluetooth module that connects a mobile telephone to an infotainment system of the motor vehicle,
the wireless connection produced between the communication unit and the apparatus is a Bluetooth connection,
the apparatus is operated in dependence upon the data that define the operating mode as soon as the wireless connection is produced, and
the apparatus is operated to continue a piece of music that was interrupted while exiting the motor vehicle.

14. The method according to claim 1, wherein
the data are synchronized between the communication unit and the central data processing device via an internet connection.

15. A control system comprising:
an apparatus that is arranged in a building;
a central data processing device containing data that define an operating mode of the apparatus;
a communication unit of a motor vehicle to synchronize with the central data processing device, to produce a wireless connection to the apparatus and to transmit to the apparatus in a wireless manner the data that define the operating mode of the apparatus, the data that define the operating mode of the apparatus being synchronized between the communication unit and the central data processing device; and
a control device to operate the apparatus in dependence upon the data that define the operating mode of the apparatus.

16. The control system according to claim 15, wherein
the wireless connection produced by the communication unit is at least one of a wireless local area network (WLAN) wireless connection, a Bluetooth wireless connection and a mobile network wireless connection.

17. The control system according to claim 15, wherein
a plurality of apparatuses are arranged in the building,
a selected apparatus of the plurality of apparatuses is selected by a user interface of the motor vehicle, and
data that define the operating mode of the selected apparatus is transmitted to the selected apparatus.

18. A method comprising:
creating a plurality of data records, each data record defining an operating mode of a home appliance system;
storing the data records in a central data processing device;
identifying a selected data record based on a communication from a motor vehicle; and
for the selected data record, activating the home appliance system to trigger the operating mode defined by the selected data record, before a driver of the motor vehicle enters a building housing the home appliance system.

19. The method according to claim 18, wherein the data records are user-specific such that each data record specifies one user's preferred operating mode for the home appliance system.

20. The method according to claim 19, wherein
the driver of the motor vehicle is identified, and
the selected data record is chosen so as to be specific to the driver of the motor vehicle.
